(19) United States
(12) Patent Application Publication
(10) Pub. No.: US 2026/0196077 A1
(43) Pub. Date: Jul. 9, 2026

(54) ARTIFICIAL INTELLIGENCE-BASED BEHAVIOR MONITORING METHOD, PROGRAM, AND DEVICE

(71) Applicant: EDINT INC, Daejeon (KR)

(72) Inventors: Dongil WON, Seoul (KR); Jihun LEE, Gwacheon (KR); Hohwan SHIN, Hwaseong (KR)

(21) Appl. No.: 19/129,686

(22) PCT Filed: Dec. 19, 2022
(86) PCT No.: PCT/KR2022/020697

§ 371 Date: May 14, 2025

(30) Foreign Application Priority Data
Nov. 15, 2022 (KR) 10-2022-0153024

(51) Int. Cl. G06V 40/20; G06V 10/70

(52) U.S. Cl. CPC G06V 40/20; G06V 10/70

(57) ABSTRACT

An artificial intelligence-based behavior monitoring method, program, and device according to one embodiment of the present disclosure are disclosed. The artificial intelligence-based behavior monitoring method includes: generating analysis results for a detection item based on observational data for a person, who is a subject of behavior monitoring, by using a deep learning model that matches at least one detection item included in each of a plurality of detection targets; and estimating a behavior of the person based on the generated analysis results by using a predetermined ruleset.

### TECHNICAL FIELD

The present disclosure relates to data analysis technology, and more particularly, to a method and device for performing estimation and monitoring based on complex determination results for a behavior of a person obtained based on artificial intelligence.

### BACKGROUND ART

In an environment constructed according to a specific purpose, there are situations where it is necessary to check the behavior taken by a person and analyze the results of the behavior taken by the person. For example, in an educational environment where a test is taken, it is necessary to monitor the behaviors taken by a test taker during the test. In particular, unlike in an offline test, it is difficult to effectively check the behaviors of the test taker and a surrounding environment in an online test. Therefore, in an environment where an online test is taken, it is more important for an administrator to check whether there is any cheating behavior by accurately analyzing the behaviors taken by each test taker in real time.

As can be seen from the examples described above, it is not easy to effectively monitor a behavior of a person and surroundings in an environment constructed online. Although there are conventional technologies that analyze a specific behavior of a person by using a detection device such as a camera, most of them analyze a specific behavior of a person based only on fragmentary information obtained in a specific situation. However, when analysis is performed based only on fragmentary information as described above, it is difficult to accurately interpret whether a person is taking a behavior, requiring determination, in a specific environment. For example, when a cheating behavior is detected by analyzing only a front image of a person in an online test environment, the limited information available from the front image increases the probability that a behavior will not be determined to be a cheating behavior even when it is suspected as a cheating behavior or the probability that a behavior will be erroneously determined to be a cheating behavior even when it is not a cheating behavior.

### DISCLOSURE

### Technical Problem

The present disclosure has been conceived in response to the above-described background art, and an object of the present disclosure is to provide a method and device capable of comprehensively determining and accurately monitoring what behavior a person takes within a specific environment based on various detection results.

However, the objects to be achieved in the present disclosure are not limited to the object mentioned above, and other objects not mentioned may be clearly understood based on the following description.

### Technical Solution

According to one embodiment of the present disclosure for achieving the above-described object, there is disclosed an artificial intelligence-based behavior monitoring method that is performed by a computing device. The artificial intelligence-based behavior monitoring method includes: generating analysis results for a detection item based on observational data for a person, who is a subject of behavior monitoring, by using a deep learning model that matches at least one detection item included in each of a plurality of detection targets; and estimating a behavior of the person based on the generated analysis results by using a predetermined ruleset.

Alternatively, the detection item may be state information identified based on a subclass of the detection target. The state information may be changeable according to the behavior of the person.

Alternatively, the plurality of detection targets may include one or more of a body part of the person, a thing excluding the person, a sound of an object associated with the behavior of the person, and the time of an object associated with the behavior of the person.

Alternatively, the deep learning model may include at least one of: a first model for estimating the pose of a person based on an image; a second model for estimating the shape and direction of the face of a person based on an image; a third model for tracking the gaze of a person based on an image; a fourth model for recognizing a thing other than a person based on an image; and a fifth model for detecting a sound element of an object associated with a behavior of a person based on at least one of an image and audio.

Alternatively, generating the analysis results for the detection item based on the observational data for the person, who is the subject of behavior monitoring, by using the deep learning model that matches at least one detection item included in each of the plurality of detection targets may include: obtaining the observational data at a predetermined cycle; and generating analysis results for the detection item, reflecting therein a behavioral result of the person performed during the predetermined cycle, by inputting the obtained observational data to at least one of the first, second, third, fourth, and fifth models.

Alternatively, the predetermined cycle may be determined in accordance with environmental conditions that are set by a client in charge of behavior monitoring.

Alternatively, estimating the behavior of the person based on the generated analysis results by using the predetermined ruleset may include: identifying analysis results that match a determination condition for each behavior class included in the predetermined ruleset among the generated analysis results; estimating accuracy of the identified analysis results and correlation between the behavior class included in the predetermined ruleset and the identified analysis results; and estimating a behavior of the person by combining the identified analysis results based on the estimated accuracy and correlation.

Alternatively, estimating the behavior of the person by combining the identified analysis results based on the estimated accuracy and correlation may include: assigning a first weight based on the estimated accuracy to each of the identified analysis results; assigning a second weight based on the estimated correlation to each of the identified analysis results; and determining whether the person has performed at least one of behavior classes included in the predetermined ruleset based on a numerical value derived by combining the first and second weights.

Alternatively, the behavior classes included in the predetermined ruleset may include: a first behavior class set by a client in charge of behavior monitoring and corresponding to a cheating behavior for a test; and a second behavior class set by the client and corresponding to an abnormal behavior unnecessary for taking the test.

According to one embodiment of the present disclosure for achieving the above-described object, there is disclosed a computer program stored in a computer-readable storage medium. The computer program causes operations for monitoring behavior based on artificial intelligence to be performed when executed by at least one processor. In this case, the operations include operations of: generating analysis results for a detection item based on observational data for a person, who is a subject of behavior monitoring, by using a deep learning model that matches at least one detection item included in each of a plurality of detection targets; and estimating a behavior of the person based on the generated analysis results by using a predetermined ruleset.

According to one embodiment of the present disclosure for achieving the above-described object, there is disclosed a computing device for monitoring behavior based on artificial intelligence. The computing device may include: a processor including at least one core; memory including program codes executable by the processor; and a network unit for obtaining observational data for a person who is a subject of behavior monitoring. In this case, the processor may generate analysis results for a detection item based on observational data for a person, who is a subject of behavior monitoring, by using a deep learning model that matches at least one detection item included in each of a plurality of detection targets, and may estimate a behavior of the person based on the generated analysis results by using a predetermined ruleset.

### Advantageous Effects

The present disclosure may provide the method and device capable of comprehensively determining and accurately monitoring what behavior a person takes within a specific environment based on various detection results.

### DESCRIPTION OF DRAWINGS

FIG. 1 is a block diagram of a computing device according to one embodiment of the present disclosure;

FIG. 2 is a block diagram showing a process of performing behavior monitoring of a computing device according to one embodiment of the present disclosure;

FIG. 3 is a block diagram showing a process of performing behavior monitoring of a computing device according to an alternative embodiment of the present disclosure;

FIG. 4a is a table summarizing analysis methods and analysis results for respective detection items according to one embodiment of the present disclosure;

FIG. 4b is a table summarizing a ruleset for behavior estimation and behavior estimation results according to one embodiment of the present disclosure;

FIGS. 5a to 5c are conceptual diagrams in each of which a per-behavior estimation process of a computing device according to one embodiment of the present disclosure is subdivided;

FIG. 6 is a flowchart showing an artificial intelligence-based behavior monitoring method according to one embodiment of the present disclosure; and

FIG. 7 is a flowchart showing a method of monitoring behavior in an online test environment according to one embodiment of the present disclosure.

### MODE FOR INVENTION

Embodiments of the present disclosure will be described in detail below with reference to the accompanying drawings so that those having ordinary skill in the art of the present disclosure (hereinafter, those skilled in the art) can easily implement the present disclosure. The embodiments presented in the present disclosure are provided to enable those skilled in the art to use or practice the content of the present disclosure. Accordingly, various modifications to embodiments of the present disclosure will be apparent to those skilled in the art. That is, the present disclosure may be implemented in various different forms and is not limited to the following embodiments.

The same or similar reference numerals denote the same or similar components throughout the specification of the present disclosure. Additionally, in order to clearly describe the present disclosure, reference numerals for parts that are not related to the description of the present disclosure may be omitted in the drawings.

The term “or” used herein is intended not to mean an exclusive “or” but to mean an inclusive “or.” That is, unless otherwise specified herein or the meaning is not clear from the context, the clause “X uses A or B” should be understood to mean one of the natural inclusive substitutions. For example, unless otherwise specified herein or the meaning is not clear from the context, the clause “X uses A or B” may be interpreted as any one of a case where X uses A, a case where X uses B, and a case where X uses both A and B.

The term “and/or” used herein should be understood to refer to and include all possible combinations of one or more of listed related concepts.

The terms “include” and/or “including” used herein should be understood to mean that specific features and/or components are present. However, the terms “include” and/or “including” should be understood as not excluding the presence or addition of one or more other features, one or more other components, and/or combinations thereof.

Unless otherwise specified herein or unless the context clearly indicates a singular form, the singular form should generally be construed to include “one or more.”

The term “N-th (N is a natural number)” used herein may be understood as an expression used to distinguish the components of the present disclosure according to a predetermined criterion such as a functional perspective, a structural perspective, or the convenience of description. For example, in the present disclosure, components performing different functional roles may be distinguished as a first component or a second component. However, components that are substantially the same within the technical spirit of the present disclosure but should be distinguished for the convenience of description may also be distinguished as a first component or a second component.

The term “obtaining” used herein may be understood to mean not only receiving data over a wired/wireless communication network connecting with an external device or a system, but also generating data in an on-device form.

Meanwhile, the term “module” or “unit” used herein may be understood as a term referring to an independent functional unit processing computing resources, such as a computer-related entity, firmware, software or part thereof, hardware or part thereof, or a combination of software and hardware. In this case, the “module” or “unit” may be a unit composed of a single component, or may be a unit expressed as a combination or set of multiple components. For example, in the narrow sense, the term “module” or “unit” may refer to a hardware component or set of components of a computing device, an application program performing a specific function of software, a procedure implemented through the execution of software, a set of instructions for the execution of a program, or the like. Additionally, in the broad sense, the term “module” or “unit” may refer to a computing device itself constituting part of a system, an application running on the computing device, or the like. However, the above-described concepts are only examples, and the concept of “module” or “unit” may be defined in various manners within a range understandable to those skilled in the art based on the content of the present disclosure.

The term “model” used herein may be understood as a system implemented using mathematical concepts and language to solve a specific problem, a set of software units intended to solve a specific problem, or an abstract model for a process intended to solve a specific problem. For example, a neural network “model” may refer to an overall system implemented as a neural network that is provided with problem-solving capabilities through training. In this case, the neural network may be provided with problem-solving capabilities by optimizing parameters connecting nodes or neurons through training. The neural network “model” may include a single neural network, or a neural network set in which multiple neural networks are combined together.

The term “image” used herein may refer to multidimensional data composed of discrete image elements. In other words, “image” may be understood as a term that refers to a digital representation of an object that can be viewed by a human eye. For example, “image” may refer to multidimensional data composed of elements corresponding to pixels in a two-dimensional image. “Image” may refer to multidimensional data composed of elements corresponding to voxels in a three-dimensional image.

The foregoing descriptions of the terms are intended to help to understand the present disclosure. Accordingly, it should be noted that unless the above-described terms are explicitly described as limiting the content of the present disclosure, the terms in the content of the present disclosure are not used in the sense of limiting the technical spirit of the present disclosure.

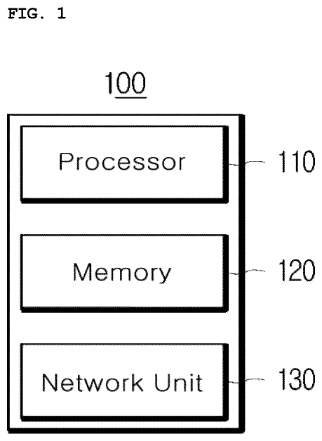

FIG. 1 is a block diagram of a computing device according to one embodiment of the present disclosure.

A computing device 100 according to one embodiment of the present disclosure may be a hardware device or part of a hardware device that performs the comprehensive processing and computation of data, or may be a software-based computing environment connected over a communication network. For example, the computing device 100 may be a server that is a main agent for performing an intensive data processing function and sharing resources, or may be a client that shares resources through interaction with a server. Alternatively, the computing device 100 may be a cloud system in which multiple servers and clients comprehensively process data while interacting with each other. Since the above description is only one example related to the type of computing device 100, the type of computing device 100 may be configured in various manners within a range understandable to those skilled in the art based on the content of the present disclosure.

Referring to FIG. 1, the computing device 100 according to one embodiment of the present disclosure may include a processor 110, memory 120, and a network unit 130. However, FIG. 1 is only an example, and the computing device 100 may further include other components for implementing a computing environment. Furthermore, only some of the disclosed components may be included in the computing device 100.

The processor 110 according to one embodiment of the present disclosure may be understood as a constituent unit including hardware and/or software for performing computing operations. For example, the processor 110 may read a computer program and perform data processing for machine learning. The processor 110 may process computational processes such as the processing of input data for machine learning, the extraction of features for machine learning, and the computation of errors based on backpropagation. The processor 110 for performing such data processing may include a central processing unit (CPU), a general purpose graphics processing unit (GPGPU), a tensor processing unit (TPU), an application specific integrated circuit (ASIC), and a field programmable gate array (FPGA). Since the types of processor 110 described above are only examples, the type of processor 110 may be configured in various manners within a range understandable to those skilled in the art based on the content of the present disclosure.

The processor 110 may generate an analysis result for each of a plurality of detection targets based on observational data for a person, who is a subject of behavior monitoring, by using a pre-trained deep learning model. In this case, the detection target may be understood as a component of observational data that serves as a criterion for estimating a behavior of a person. Furthermore, the analysis result for the detection target may be information indicating what kind of behavior a person takes based on the detection target present in the observational data. More specifically, the detection target may be any one of a body part of the person, a thing other than the person, a sound of an object associated with a behavior of the person, and the time of an object associated with the behavior of the person. The object related to a behavior of a person may be a body part of the person or a thing that can change due to the influence of the behavior of the person. Furthermore, the analysis result for the detection target may be information about the behavior performed by a person based on a body part of the person, a thing, the sound of an object, or the time of an object present in the observational data. That is, the processor 110 may generate an analysis result for each of the detection targets present in the observational data as basic data for detecting a specific behavior of a person performed under a specific environment for behavior monitoring by inputting the observational data to a pre-trained deep learning model.

The processor 110 may estimate a specific behavior of a person based on the analysis results, generated via the deep learning model, by using a predetermined ruleset. In this case, the ruleset may be a set of behavior classes that are detection candidates in a specific environment for behavior monitoring and determination conditions for the respective behavior classes. Furthermore, the ruleset may be generated, changed, or modified by an administrator who has constructed the specific environment for behavior monitoring. That is, the processor 110 may estimate a behavior of the person present in the observational data by comprehensively determining the analysis results for the individual detection targets present in the observational data based on the ruleset that can be customized to fit the specific environment for behavior monitoring. For example, assuming that the environment for behavior monitoring is an environment for an online test, the ruleset generated by a client of a test supervisor may be a set of determination conditions for each of a cheating behavior for a test, an abnormal behavior that is not a cheating behavior but may be suspected as a cheating behavior, and determination conditions for the cheating behavior and/or the abnormal behavior. The processor 110 may identify the analysis results of the deep learning model that match the determination conditions included in the above-described ruleset. Furthermore, the processor 110 may combine the analysis results of the deep learning model that match the determination conditions. In this case, the combination of the analysis results that match the determination conditions may be understood as a task of performing a mathematical operation based on the accuracy for each of the analysis results and the correlation with the cheating behavior or the abnormal behavior. The processor 110 may determine whether the test taker has performed the cheating behavior or abnormal behavior included in the ruleset under a situation, determined via the observational data, based on the numerical values derived by combining the analysis results of the deep learning model that match the determination conditions.

In this manner, the processor 110 may derive individual pieces of information indicating what behavior a person takes based on various detection targets by using an artificial intelligence, and may monitor a specific behavior of a person by comprehensively determining the individual pieces of information derived for respective detection targets based on a ruleset generated to fit a specific environment. That is, the processor 110 performs monitoring by comprehensively considering all types of information obtainable from observational data, so that a behavior of a person to be detected in a specific environment can be estimated more precisely and accurately and an effective monitoring environment can be provided.

The memory 120 according to one embodiment of the present disclosure may be understood as a constituent unit including hardware and/or software for storing and managing data that is processed in the computing device 100. That is, the memory 120 may store any type of data generated or determined by the processor 110 and any type of data received by the network unit 130. For example, the memory 120 may include at least one type of storage medium of a flash memory type, hard disk type, multimedia card micro type, and card type memory, random access memory (RAM), static random access memory (SRAM), read-only memory (ROM), electrically erasable programmable read-only memory (EEPROM), programmable read-only memory (PROM), magnetic memory, a magnetic disk, and an optical disk. Furthermore, the memory 120 may include a database system that controls and manages data in a predetermined system. Since the types of memory 120 described above are only examples, the type of memory 120 may be configured in various manners within a range understandable to those skilled in the art based on the content of the present disclosure.

The memory 120 may structure, organize and manage the data required for the processor 110 to perform operations, combinations of data, and the program codes executable by the processor 110. For example, the memory 120 may store the observational data received via the network unit 130 to be described later. The memory 120 may store the program codes that operate the processor 110 to train a deep learning model, the program codes that operate the processor 110 to estimate a behavior of a person by using a trained deep learning model, various types of data that are generated as program codes are executed, etc.

The network unit 130 according to one embodiment of the present disclosure may be understood as a constituent unit that transmits and receives data via any type of known wired/wireless communication system. For example, the network unit 130 may perform data transmission and reception by using a wired/wireless communication system such as a local area network (LAN), a wideband code division multiple access (WCDMA) network, a long term evolution (LTE) network, the wireless broadband Internet (WiBro), a 5th generation mobile communication (5G) network, an ultra-wideband wireless communication network, a ZigBee network, a radio frequency (RF) communication network, a wireless LAN, a wireless fidelity network, a near field communication (NFC) network, or a Bluetooth network. Since the above-described communication systems are only examples, the wired/wireless communication system for the data transmission and reception of the network unit 130 may be applied in various manners other than the above-described examples.

The network unit 130 may receive data required for the processor 110 to perform computation through wired/wireless communication with any system, any server, any client, or the like. Furthermore, the network unit 130 may transmit the data, generated through the computation of the processor 110, through the wired/wireless communication with any system, any server, any client, or the like. For example, the network unit 130 may receive observational data of a person, who is a subject of behavior monitoring, through wired/wireless communication with a detection device such as a camera, a client equipped with a detection device, or the like. Furthermore, the network unit 130 may receive user input through a user interface implemented in the detection device or the client equipped with the detection device. The network unit 130 may transmit various types of data generated through the computation of the processor 110 based on the observational data through wired/wireless communication with the detection device, the client equipped with a detection device, or the like.

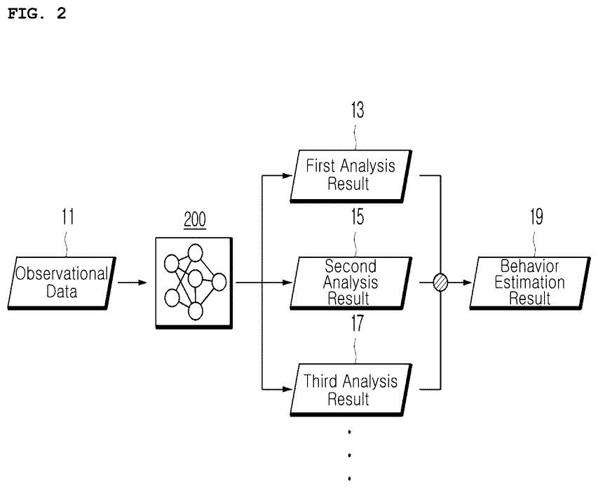

FIG. 2 is a block diagram showing a process of performing behavior monitoring of a computing device according to one embodiment of the present disclosure.

Referring to FIG. 2, the computing device 100 according to one embodiment of the present disclosure may input observational data 11 for a person, who is a subject of behavior monitoring, to a pre-trained deep learning model 200. In this case, the observational data 11 may be understood as data that can be obtained for a person who takes a behavior in a specific environment for behavior monitoring.

For example, the observational data 11 may be at least one of an image and video captured by a camera installed in a space for an online test and an audio collected by a microphone installed in a space for an online test. In this case, a detection device for the observational data 11, such as a camera and a microphone, may be a component of a client that is possessed by a test taker. When an online test begins, the detection device included in a client of the test taker may generate at least one of an image, video, and audio of the test taker or the test space. The computing device 100 may obtain the observational data 11 generated by the client of the test taker through wired/wireless communication with the client of the test taker. Furthermore, the computing device 100 may input the obtained observational data 11 to the pre-trained deep learning model 200.

The computing device 100 may generate an analysis result for at least one detection item included in each of a plurality of detection targets via the deep learning model 200 to which the observational data 11 is input. In this case, the detection item may be state information that is identified based on a subclass of a detection target. Furthermore, the detection item may represent a state that can change depending on the behavior of a person.

For example, when the detection target is a body part of a person, the subclasses of the detection target may be divided into the face, the arms, etc. The face may be divided into the eyes, the nose, the mouth, and the ears. Furthermore, the arms may be divided into the hands, the palms, the fingers, etc. The detection item is state information that can be detected based on each of the subclasses of the detection target, such as a gaze direction, the presence or absence of an utterance, a hand position, or a palm direction. In other words, the detection item may represent a specific state or appearance that can appear when the subclass of the detection target moves or changes according to the behavior of a person.

In other words, the computing device 100 may generate a plurality of analysis results 13, 15, and 17 for various detection items by inputting the observational data 11 to the pre-trained deep learning model 200. In this case, the first analysis result 13, second analysis result 15, and third analysis result 17 generated via the deep learning model 200 may each be matched to each of the detection items such as a gaze direction, the presence or absence of an utterance, a hand position, and a palm direction.

For example, assuming that the environment for behavior monitoring is an environment for an online test, the first analysis result 13 matching a gaze direction may indicate the result of detecting whether a test taker is gazing at a display for checking test paper. The second analysis result 15 matching the presence or absence of an utterance may indicate the result of detecting whether the shape of the mouth of the test taker has changed. The third analysis result 17 matching a hand position may indicate the result of detecting whether the left or right hand of the test taker is moving within a reference space determined according to the arrangement of the body of the test taker and a desk. In this manner, the computing device 100 may individually generate analysis results for at least one detection item included in each of the plurality of detection targets by using the pre-trained deep learning model 200. Through this computational process, the computing device 100 may obtain various types of information that can be used to infer one behavior from the observational data 11 and utilize it in a computational process for behavior estimation to be described later.

Meanwhile, the deep learning model 200 may be a neural network-based model capable of processing single data, or may be a neural network-based model capable of processing sequential data. For example, the deep learning model 200 may include a convolutional neural network that receives an image corresponding to single data, extracts features of the image, and recognizes an object. Furthermore, the deep learning model 200 may include a recurrent neural network that receives sequential data such as audio, extracts features of the sequential data, and interprets them. In addition to the examples described above, a neural network capable of processing single data or sequential data may be included in the deep learning model 200 of the present disclosure.

The deep learning model 200 may be pre-trained using labels that use pre-verified analysis results for the detection item of the detection target present in observational data as ground truth. More specifically, in a training process, the deep learning model 200 may receive observational data and generate analysis results for each detection item of detection targets present in the observational data. Furthermore, the deep learning model 200 may perform learning by repeatedly performing the process of comparing the generated analysis results with the labels and updating the parameters of the neural network based on the comparison results. In this case, an operation for comparison may be performed in the direction in which the loss calculated via a loss function such as cross entropy is minimized. Although the above-described example is a learning process based on supervised learning, the deep learning model 200 may also be trained based on semi-supervised learning, unsupervised learning, self-supervised learning, or the like in addition to supervised learning.

Referring to FIG. 2, the computing device 100 may generate a behavior estimation result 19 for a person, who is a monitoring subject, by combining the plurality of analysis results generated via the deep learning model 200. In this case, the computing device 100 may use a predetermined ruleset in accordance with a specific environment for behavior monitoring. More specifically, the computing device 100 may identify analysis results, which match determination conditions for each behavior class included in the predetermined ruleset, among the analysis results generated via the deep learning model 200. The computing device 100 may estimate the accuracy of the identified analysis results and the correlation between the behavior class included in the predetermined ruleset and the identified analysis results. Furthermore, the computing device 100 may estimate the behavior of a person, which should be detected for behavior monitoring under a specific environment, by combining the analysis results based on the estimated accuracy and correlation. The computing device 100 may detect a specific behavior by determining it closely and accurately based on various types of information via this computational process.

For example, assuming that the environment for behavior monitoring is an environment for an online test, the computing device 100 may identify analysis results corresponding to the determination conditions of a first behavior class for cheating and/or the determination condition of a second behavior class for abnormal behavior among the first analysis result 13 matching a gaze direction, the second analysis result 15 matching the presence or absence of an utterance, and the third analysis result 17 matching a hand position by screening the predetermined ruleset. The computing device 100 may estimate the accuracy of the analysis results corresponding to the first behavior class and/or the second behavior class among the first analysis result 13, the second analysis result 15, and the third analysis result 17. In this case, the accuracy may be understood as a quantitative indicator indicating how accurately the deep learning model 200 has performed analysis. Furthermore, the computing device 100 may estimate the correlation between the analysis results, corresponding to the first behavior class and/or the second behavior class, and the first behavior class and/or the second behavior class according to the predetermined ruleset. In this case, the correlation may be understood as a quantitative indicator indicating the degree to which a specific analysis result influences the determination of a specific behavior class. The computing device 100 may assign weights to the analysis results corresponding to the first behavior class and/or the second behavior class according to the estimated accuracy and correlation. The computing device 100 may derive numerical values for finally determining one of the behavior classes included in the predetermined ruleset to be the behavior estimation result 19 by combining the weights assigned based on the accuracy and the correlation. In this case, the numerical values may be values matching the grades of the behavior classes included in the predetermined ruleset. That is, the computing device 100 may select one of the behavior classes included in the predetermined ruleset based on the numerical values derived from the combination of the weights, thereby deriving it as the behavior estimation result 19.

When there is no analysis result that matches the determination condition of the first behavior class or the determination condition of the second behavior class among the first analysis result 13, the second analysis result 15, and the third analysis result 19, the computing device 100 may determine that the cheating or abnormal behavior of the test taker has not occurred based on the currently input observational data 11. Then, the computing device 100 may perform the above-described analysis and behavior estimation process again by inputting observational data at a subsequent time point to the deep learning model 200.

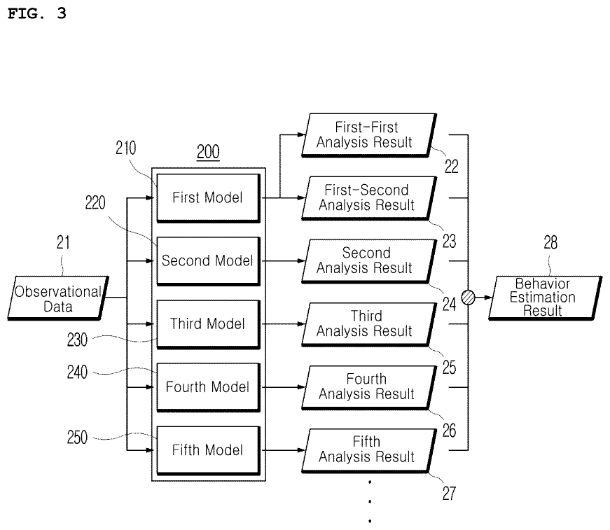

FIG. 3 is a block diagram showing a process of performing behavior monitoring of a computing device according to an alternative embodiment of the present disclosure.

The computing device 100 according to an alternative embodiment of the present disclosure may generate an analysis result for at least one detection item included in a plurality of detection targets based on observational data 21 for a person, who is a subject of behavior monitoring, by using a deep learning model 200 including one or more sub-models. For example, referring to FIG. 3, the deep learning model 200 may include a first model 210 that estimates the pose of a person based on an image, a second model 220 that estimates the shape and direction of the face of a person based on an image, a third model 230 that tracks the gaze of a person based on an image, a fourth model 240 that recognizes a thing other than a person based on an image, and a fifth model 250 that detects a sound element of an object related to the behavior of a person based on at least one of an image and an audio. In FIG. 3, the deep learning model 200 is illustrated as including all the first to fifth models 210 to 250, but is not limited thereto. That is, the deep learning model 200 may include at least one of the first model 210, the second model 220, the third model 230, the fourth model 240, and the fifth model 250.

According to an alternative embodiment of the present disclosure, each of the first to fifth models 210 to 250 may be matched to at least one detection item included in each of a plurality of detection targets. That is, each of the first to fifth models 210 to 250 may be pre-trained to derive an analysis result optimized for a detection item according to a specific environment for behavior monitoring. Furthermore, each of the first to fifth models 210 to 250 may receive observational data 21 and derive an analysis result for a learned detection item. In this case, the first to fifth models 210 to 250 may each be matched to two or more different detection items according to a specific environment for behavior monitoring and derive two or more analysis results.

For example, the first model 210 that receives an image and estimates the pose of a person may be trained to derive an analysis result for each of two different detection items corresponding to the hand position and palm direction included in the detection target of the body part. Accordingly, the first model 210 may receive the observational data 21 and output a first-first analysis result 22 indicating the result of detecting whether the left or right hand of a test taker is moving within a reference space determined according to the arrangement of the body of the test taker and a desk. Furthermore, the first model 210 may receive the observational data 21 and output a first-second analysis result 23 indicating the result of determining whether the palm direction of the test taker matches the gaze direction of the test taker. Although not shown in FIG. 3, each of the second to fifth models 220 to 250 may generate analysis results for two or more different detection items, like the first model 210 described above.

When the first to fifth models 210 to 250 each optimized for one or more detection items are utilized, a computational process for deriving an analysis result for each detection item from the observational data 21 may be processed efficiently and rapidly. Furthermore, a system capable of performing behavior monitoring in real time through efficient and rapid processing via the first to fifth models 210 to 250 may be implemented

Meanwhile, the first model 210 may receive an image of a person and detect a pose taken by the person present in the image. For example, the first model 210 may receive an image, may classify a body part and a background based on a plurality of feature points for identifying the pose of the person, and may generate a mask for the body part. Furthermore, the first model 210 may estimate what pose the person is taking by analyzing the mask for the body part. For this pose estimation, the first model 210 may include a neural network optimized for image processing. Furthermore, the first model 210 may be trained based on not only supervised learning but also semi-supervised learning, unsupervised learning, self-supervised learning, etc.

The second model 220 may receive an image of a person, and may detect the shape and direction of the face of the person present in the image. For example, the second model 220 may extract the face area of a person from an image of the person and generate a crop image. The second model 220 may generate a feature map based on the crop image. Furthermore, the second model 220 may perform an attention operation based on the generated feature map and an affine matrix based on the crop image to generate a mesh-type 3D landmark for the face of the person. The second model 220 may estimate the shape of the face based on the 3D landmark, and may estimate the direction of the face based on changes in the feature points included in the 3D landmark. For the estimation of the shape and direction of the face, the second model 220 may include a neural network optimized for image processing. Furthermore, the second model 220 may be trained based on not only supervised learning but also semi-supervised learning, unsupervised learning, self-supervised learning, etc.

The third model 230 may receive an image of a person and track the gaze of the person present in the image. For example, the third model 230 may extract the face area of a person from an image of the person and generate a crop image. The third model 230 may extract features based on the crop image and recognize the eye of the person. Furthermore, the third model 230 may track the gaze of the person by analyzing the movement and change of the pupil included in the recognized eye. For this gaze tracking, the third model 230 may include a neural network optimized for image processing. Furthermore, the third model 230 may be trained based on not only supervised learning but also semi-supervised learning, unsupervised learning, self-supervised learning, etc.

The fourth model 240 may receive an image of objects, and may detect a thing other than a person among the objects present in the image. For example, the fourth model 240 may receive an image and classify a person and a thing among objects present in the image. The fourth model 240 may estimate the type and location of the thing in the image by performing semantic segmentation based on the thing identified through classification. In this case, pixel-based, edge-based, and area-based methods may be applied without limitation for the semantic segmentation. For the estimation of the type and location of the thing, the fourth model 240 may include a neural network optimized for image processing. Furthermore, the fourth model 240 may be trained based on not only supervised learning but also semi-supervised learning, unsupervised learning, self-supervised learning, etc.

The fifth model 250 may receive an image or audio representing a sound occurring in a space where a person, who is a subject of behavior monitoring, is present, and may detect sound elements related to the behavior of the person. For example, the fifth model 250 may extract features of sound elements from an image representing a sound waveform or an audio indicating a sound waveform signal. The fifth model 250 may estimate the size of a sound occurring in a space where a person, who is a subject of behavior monitoring, is present, the subject of the generation of the sound, and the type of sound language, based on the features of the sound elements extracted from the image or audio. For the estimation of the sound, the fifth model 250 may include a neural network optimized for the processing of sequential data. Furthermore, the fifth model 250 may be trained based on not only supervised learning but also semi-supervised learning, unsupervised learning, self-supervised learning, etc.

Meanwhile, the computational process of deriving a behavior estimation result 28 based on analysis results 22, 23, 24, 25, 26, and 27 output by each of the first to fifth models 210 to 250 corresponds to the computational process of deriving the behavior estimation result 19 of the above-described FIG. 2, and thus, a detailed description thereof will be omitted below. Furthermore, the specific types of the detection targets, detection items, and analysis results described above via FIGS. 2 and 3 are only examples, and thus, the types of detection targets, detection items, and analysis results may be configured in various manners within a range understandable to those skilled in the art based on the content of the present disclosure.

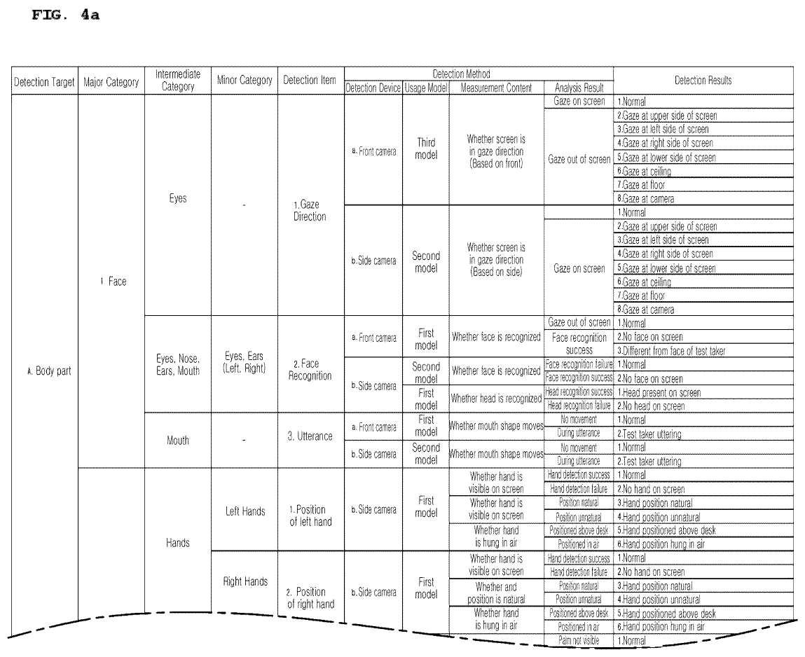

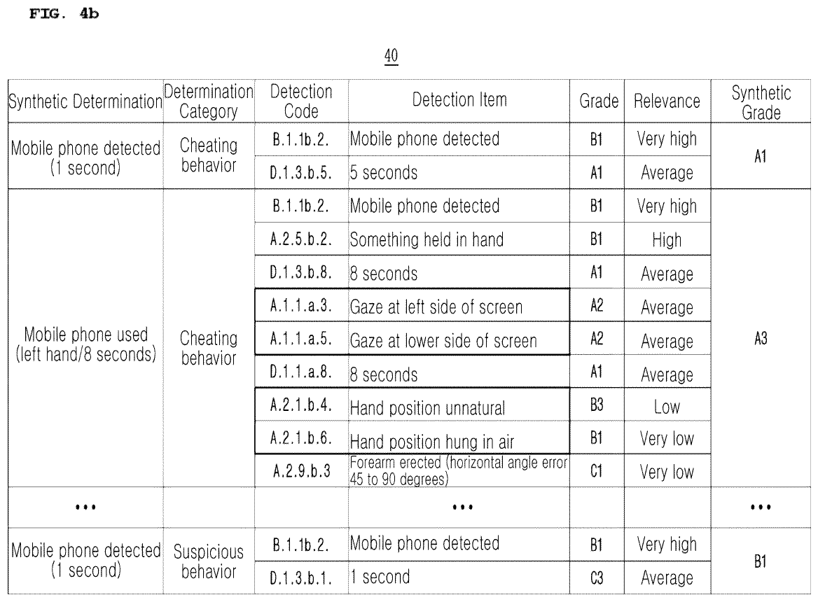

FIG. 4a is a table summarizing analysis methods and analysis results for respective detection items according to one embodiment of the present disclosure. FIG. 4b is a table summarizing a ruleset for behavior estimation and behavior estimation results according to one embodiment of the present disclosure.

Referring to the table 30 of FIG. 4a, the detection target according to one embodiment of the present disclosure may be divided into subclasses that are further subdivided into major, medium, and minor categories. Furthermore, detection items may be divided based on the subclasses of the detection target. A detection item corresponds to state information measured based on the corresponding subclass of the detection target, and may be change information that may appear according to the behavior of a person.

For example, based on a detection target that is a body part, the subclasses of the detection target may be divided into large categories including the face, the arms, etc., medium categories including the eyes, the nose, the mouth, the ears, the hands, the palms, the fingers, etc., and small categories that distinguishes each of the medium categories into left or right according to the direction. Furthermore, the detection items may be divided to match the medium and small categories of the detection target. More specifically, the detection items may be divided into a gaze direction measured based on the eyes, a face measured based on the eyes, the nose, the ears, and the mouth, an utterance measured based on the mouth, a hand position measured based on the hand, a palm direction measured based on the palm, and a hand action measured based on the fingers.

A plurality of deep learning models according to one embodiment of the present disclosure may be individually matched to detection items. In order to efficiently perform analysis for the purpose of analysis for each detection item, each of the plurality of deep learning models may be classified according to the detection item. In this case, two or more deep learning models may be used to analyze one detection item according to the classification, and one deep learning model may be used to analyze two or more detection items.

For example, a second model that detects the shape and direction of the face of a person and a third model that tracks the gaze of a person may be matched to a detection item that is a gaze direction. The second model that matches the gaze direction may detect whether the gaze direction of a person departs from a screen that outputs specific information by detecting the shape and direction of the face of the person. Furthermore, the third model that matches the gaze direction may detect whether the gaze direction of a person departs from a screen by detecting the gaze of the person. As shown in the table 30 of FIG. 4a, the outputs of the second and third models may be used as individual analysis results for the gaze direction. Furthermore, although not shown in the table 30 of FIG. 4a, the outputs of the second and third models can be combined into one analysis result based on priority, accuracy, or the like and used to estimate a behavior of a person.

The third model that matches a detection item that is a gaze direction may also be matched to other detection items such as face recognition and utterance. The third model that tracks the gaze of a person may derive an analysis result for a gaze direction, an analysis result for face recognition, and an analysis result for utterance based on input data. That is, when observational data for a person who is the subject of behavior monitoring is input, the plurality of deep learning models according to one embodiment of the present disclosure may each analyze one or more matched detection items based on the input data. The computing device 100 according to one embodiment of the present disclosure may analyze all conditions, defined to determine a behavior to be monitored, with one piece of observational data at once in real time through matching of models to individual detection items.

Referring to the table 40 of FIG. 4b, a ruleset according to one embodiment of the present disclosure may include behavior classes that are monitoring candidates and determination conditions for the behavior classes. In this case, the behavior classes may correspond to the comprehensive determinations and determination classes shown in the table 40 of FIG. 4b, and the determination conditions may correspond to the detection items shown in the table 40 of FIG. 4b.

For example, in an online test environment, the behavior classes included in a ruleset may be divided into cheating and abnormal behaviors. Furthermore, the cheating and abnormal behaviors included in the ruleset may each be defined by the ruleset to specifically indicate what behavior or situation it represents. Furthermore, determination conditions indicating what combination of behaviors each of the cheating and abnormal behaviors included in the ruleset is determined to be may be matched to each class and defined by the ruleset. More specifically, a cheating behavior corresponding to a situation in which a mobile phone is detected for more than 5 seconds may be detected by a combination of the determination condition that a mobile phone is detected and the determination condition that the mobile phone is exposed for more than 5 seconds. Accordingly, in the ruleset, the cheating behavior corresponding to a situation in which a mobile phone is detected for more than 5 seconds may be defined as a behavior class, and the determination condition that a mobile phone is detected and the determination condition that the mobile phone is exposed for more than 5 seconds may be defined to match the corresponding class. In this case, each determination condition may be assigned an identification code corresponding to the detection code shown in the table 40 of FIG. 4b. The identification code assigned to the determination condition may be used to check which detection target, detection item, detection device, and detection result each determination condition is derived from.

The grades shown in the table 40 of FIG. 4b may correspond to numerical values that are calculated based on weights according to the detection accuracy for the combination of determination conditions. The relevance levels shown in the table 40 of FIG. 4b may correspond to numerical values that are calculated based on weights according to correlation for the combination of determination conditions. Furthermore, the comprehensive grades shown in the table 40 of FIG. 4b may correspond to numerical values that are calculated based on the grades and relevance levels of the analysis results of the deep learning models that match the determination conditions.

For example, assuming that four analysis results corresponding to the bold boxes shown in the table 30 of FIG. 4a are derived, the determination conditions matching the four analysis results in the ruleset may be identified as the bold boxes shown in the table 40 of FIG. 4b. Each of the four analysis results matched to the determination conditions may be assigned a first weight according to the output accuracy for each model and classified as a grade such as A1, A2, B1, C1, or the like. Furthermore, each of the four analysis results matched to the determination conditions may be assigned a second weight according to the correlation with a matched behavior class and classified as a relevance level such as very high, high, average, low, or very low. When each of the four analysis results matching the determination conditions is classified according to the grade and the relevance, the comprehensive grade for the final determination may be calculated based on Equation 1 below by combining the four numerical values, and the final behavior class may be determined according to the calculated comprehensive grade.

Comprehensive Grade=Average of Total Sums of (Grade for Each Analysis Result×Relevance Level for Each Analysis Result) (1)

Referring to the table 30 of FIG. 4a, in order to completely determine the cheating behavior of using a mobile phone with the left hand for 8 seconds, it can be seen that all eight determination conditions need to match analysis results. However, in the case where a final determination is performed based on the grade and the relevance level as in the above-described example of the present disclosure, even when only four determination conditions, not all eight determination conditions, are checked with analysis results, the cheating behavior of using a mobile phone with the left hand for 8 seconds may be detected with a high probability. In other words, in the case where an operation of combining ground behaviors is performed based on the detection accuracy of the deep learning model and the correlation between an analysis result and a specific behavior class as in this disclosure, even when not all the determination conditions defined in the ruleset are satisfied, a specific behavior may be accurately estimated with only the analysis results derived through the deep learning model.

In addition to the example described above, various cheating or abnormal behaviors may be defined and generated as a ruleset by an administrator who constructs an online test environment. In addition to the online test environment, the computing device 100 according to one embodiment of the present disclosure may be applied to various monitoring environments.

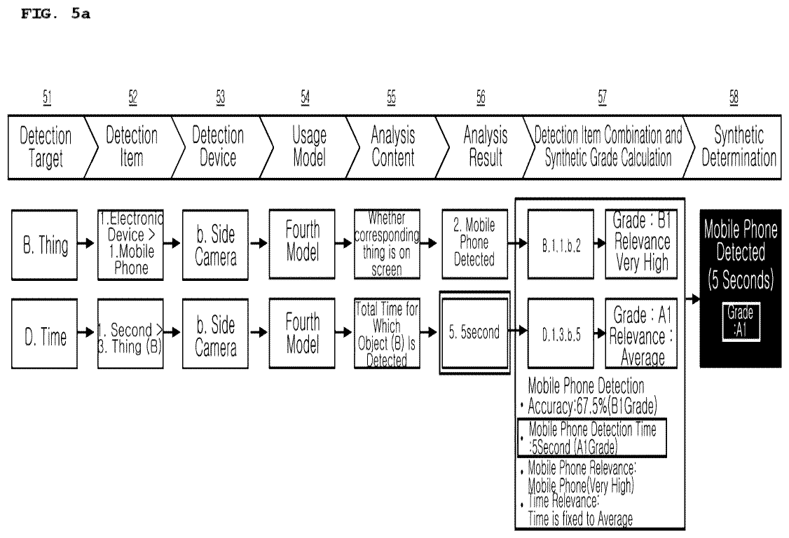

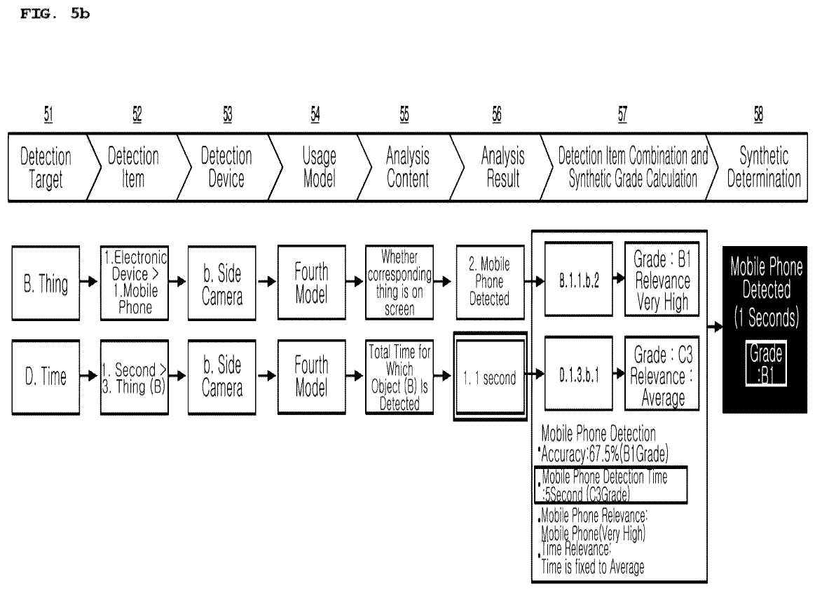

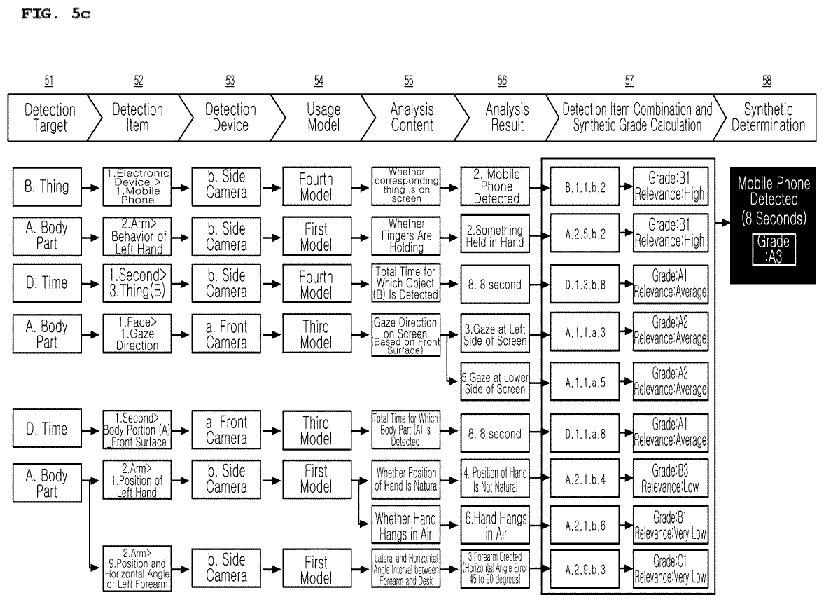

FIGS. 5a to 5c are conceptual diagrams in each of which a per-behavior estimation process of a computing device according to one embodiment of the present disclosure is subdivided.

When FIGS. 5a and 5b are compared with each other, it can be seen that although the same two detection targets were analyzed, different results were derived depending on the detailed differences in the analysis results. More specifically, when an analysis result in which the output of the deep learning model is 5 seconds is derived based on a detection item that is time as shown in FIG. 5a, the human behavior may be estimated as a cheating behavior in which a mobile phone was detected for more than 5 seconds. In contrast, when an analysis result in which the output of the deep learning model is 1 second is derived based on the detection item that is time as shown in FIG. 5b, the human behavior may be estimated as an abnormal behavior in which a mobile phone was detected for more than 1 second. In this case, the abnormal behavior may refer to a behavior that is not a cheating behavior but may be suspected as a cheating behavior. The computing device 100 according to one embodiment of the present disclosure may precisely interpret the above-described differences and accurately distinguish between cheating and abnormal behaviors by deriving analysis results for respective detection items through the deep learning models and combining the derived analysis results based on the accuracy and the correlation.

Referring to FIG. 5c, it can be seen that the computing device 100 according to one embodiment of the present disclosure detected the cheating behavior of using a mobile phone with the left hand for 8 seconds by comprehensively examining the results of analyzing detection results for various detection items included in various detection targets. The computing device 100 may individually derive analysis results for respective different detection items, such as the action of the left hand, the position of the left hand, the position of the left forearm, and the lateral horizontal angle, for a single detection target, which is a body part, via individually matched deep learning models. Furthermore, the computing device 100 may precisely determine a cheating behavior by combining the analysis results for respective detection items derived using the deep learning models based on the grade based on the detection accuracy and the relevance level based on the correlation. When the analysis results are derived for the respective detection items via the deep learning models that are matched to the detection items and the behavior is finally determined by synthesizing all the individual results in this manner, a highly reliable behavior estimation result may be obtained.

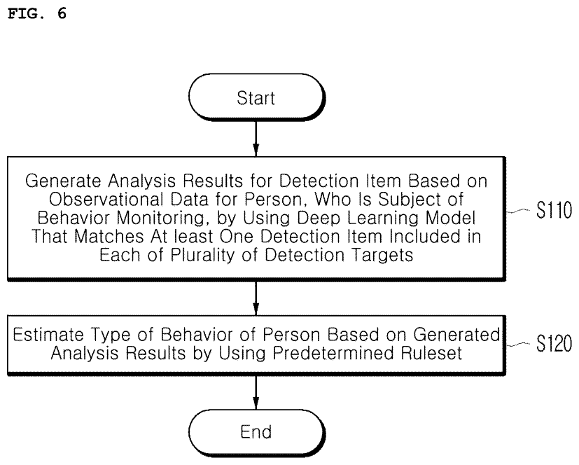

FIG. 6 is a flowchart showing an artificial intelligence-based behavior monitoring method according to one embodiment of the present disclosure.

Referring to FIG. 6, the computing device 100 according to one embodiment of the present disclosure may generate analysis results for detection items based on observational data for a person, who is a subject of behavior monitoring, by using deep learning models that each match at least one detection item included in each of a plurality of detection targets in step S110. More specifically, the computing device 100 may obtain observational data at a predetermined cycle. In this case, the predetermined cycle may be determined in accordance with environmental conditions set via a client in charge of behavior monitoring. When a manager of a specific environment for behavior monitoring sets environmental conditions via the client, the client may transmit observational data to the computing device 100 in accordance with the cycle determined according to the set conditions. The observational data may be at least one of an image, video, or audio obtained by capturing a space constructed in accordance with environmental conditions around a person. The computing device 100 may receive observational data transmitted from the client in accordance with the predetermined cycle. Furthermore, the computing device 100 may generate an analysis result for the detection item reflecting therein the result of the human behavior performed during the predetermined cycle by inputting the obtained observational data to at least one of the first model for pose estimation, the second model for facial shape and direction estimation, the third model for eye tracking, the fourth model for object recognition, and the fifth model for sound element detection.

The computing device 100 may estimate a human behavior based on the analysis results, generated via step S110, by using a ruleset in step S120. In this case, the ruleset may be pre-determined in accordance with the environmental conditions set by the client in charge of behavior monitoring. More specifically, the computing device 100 may identify analysis results that match determination conditions for respective behavior classes included in the pre-determined ruleset among the analysis results generated via step S110. The computing device 100 may estimate the accuracy of the identified analysis results and the correlation between the behavior classes included in the ruleset and the identified analysis results. Furthermore, the computing device 1000 may estimate the human behavior by combining the identified analysis results based on the estimated accuracy and correlation. For example, the computing device 100 may perform the step of assigning a first weight based on the estimated accuracy to each of the identified analysis results, the step of assigning a second weight based on the estimated correlation to each of the identified analysis results, and the step of determining whether a human has performed at least one of the behavior classes included in the predetermined ruleset based on the numerical value derived by combining the first and second weights. In this case, the behavior class included in the predetermined ruleset may include a first behavior class corresponding to cheating in a test and a second behavior class corresponding to a behavior that is not cheating but may be suspected as cheating or an abnormal behavior that is unnecessary for taking a test, which are set via the client in charge of behavior monitoring. For example, the behavior of checking a mobile phone for about 1 second to check the time is not a cheating behavior but may be suspected as cheating, so that it may be preset as a second behavior class, not as a first behavior class. The type of above-described behavior class is only one example, and the types of behavior classes may be configured in various manners within a range understandable to those skilled in the art based on the content of the present disclosure.

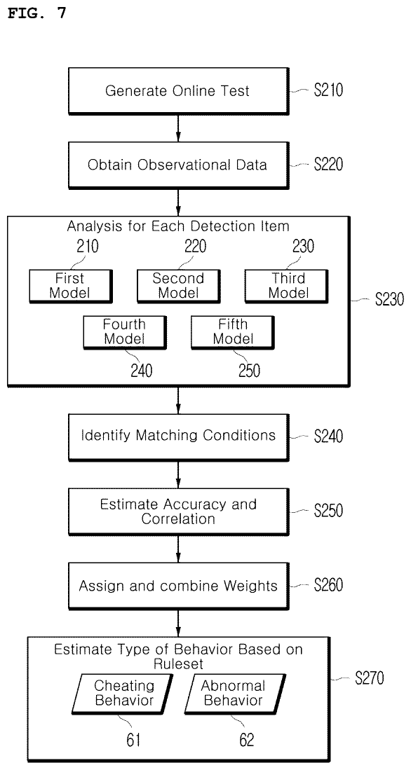

FIG. 7 is a flowchart showing a method of monitoring behavior in an online test environment according to one embodiment of the present disclosure.

Referring to FIG. 7, the computing device 100 according to one embodiment of the present disclosure may generate an online test based on a user request input via an online test host client in step S210. In this case, environmental conditions for an online test, a ruleset for the monitoring of the behavior of a test taker, and/or the like may be determined by reflecting therein the user request input via the host client. For example, the computing device 100 may determine the cycle at which observational data is obtained, a ruleset including definitions and determination conditions for a cheating behavior 61 or an abnormal behavior 62, and/or the like based on a user request input via the host client. The ruleset may be dynamically updated in a process in which the computing device 100 repeatedly performs behavior estimation after having been generated in response to a user request.

Once the online test has been generated in step S210, the computing device 100 may obtain observational data in accordance with the predetermined cycle in step S220. For example, the computing device 100 may obtain observational data at intervals of 100 ms to 1 s through wired/wireless communication with a detection device installed in a test space. In this case, the detection device may be a component equipped in the client of the test taker, or may be a component of the computing device 100. Furthermore, the cycle at which the observational data is obtained may be determined in advance in accordance with the environmental conditions of the online test via step S210.

The computing device 100 may perform per-detection item analysis to estimate the cheating behavior 61 or abnormal behavior 62 included in the ruleset based on the observational data obtained in accordance with the predetermined cycle in step S230. In this case, the computing device 100 may use the plurality of deep learning models 210, 220, 230, 240, and 250 that match at least one detection item. The plurality of deep learning models 210, 220, 230, 240, and 250 may generate per-detection item analysis results based on the detection target matching at least one detection item and present in the observational data. In this case, the per-detection item analysis results are each state information measured based on a detection item, and may each be information that can change depending on the behavior of a person. For example, the first model 210 may receive observational data, and may analyze whether the location of the left hand is adjacent to a desk based on a detection item that is the location of the left hand. The first model 210 may perform analysis for other detection items included in the detection target, which is the body part, in addition to the position of the left hand. The second model 220 may receive observational data, and may analyze whether the shape of the mouth of the test taker changes based on a detection item that is an utterance. The third model 230 may receive observational data, and may analyze whether the gaze of the test taker departs from a display area where test questions are output based on a detection item that is a gaze direction. The fourth model 240 may receive observational data, and may detect whether a mobile phone present within a predetermined radius around the test taker based on a detection item that is a mobile phone among objects. Furthermore, when a mobile phone is present, the fourth model 240 may measure the time for which the mobile phone is exposed within the predetermined radius based on a detection item that is time. The fifth model 250 may receive observational data, and may analyze a subject who has generated a sound within the test space based on a detection item that is a sound generating subject. The above-described examples are intended to help to understand the content of the present disclosure, so that the per-model analysis results of the present disclosure are not limited to the above-described examples.

The computing device 100 may identify analysis results that match the determination conditions included in the predetermined ruleset among the per-detection item analysis results derived via step S230. The computing device 100 may identify matching analysis results by comparing determination conditions for each of the cheating behavior 61 and the abnormal behavior 62 defined in the predetermined ruleset with the per-detection item analysis results derived via step S230. In this case, when there are no matching results, the computing device 100 may perform the process starting from step S220 again.

The computing device 100 may estimate accuracy and correlation for the analysis results, identified via step S240, in step S250. The computing device 100 finally determines the analysis results, matching the determination conditions included in the ruleset, to be the cheating behavior 61 or the abnormal behavior 62. Accuracy and correlation may be estimated to determine the weights to be given to the analysis results. In this case, the accuracy may be estimated based on the detection accuracy of each of the plurality of deep learning models 210, 220, 230, 240, and 250. Furthermore, the correlation may be estimated based on how much the analysis results identified via step S240 influence the determination of a specific cheating behavior or a specific abnormal behavior.

The computing device 100 may assign weights to the analysis results identified via step S240 according to the accuracy and correlation estimated via step S250. Furthermore, the computing device 100 may generate a basis for determining the cheating behavior 61 or the abnormal behavior 62 by combining the analysis results to which the weights have been assigned. For example, the computing device 100 may assign higher weights to the analysis results identified via step S240 as the accuracy estimated via step S250 increases, and may also assign higher weights as the correlation increases. The computing device 100 may derive numerical values for determining the cheating behavior 61 or the abnormal behavior 62 through a mathematical operation of combining the weights assigned according to the level of the accuracy and the weights assigned according to the level of the correlation for all the analysis results identified via step S240.

The computing device 100 may estimate any one of the types of behaviors included in the ruleset based on the numerical values derived through the combination of step S260. The computing device 100 may estimate a specific cheating behavior or a specific abnormal behavior corresponding to the numerical value, derived through the combination of step S260 among the types of behaviors included in the ruleset, as the behavior of a person who is the subject of observation.

The various embodiments of the present disclosure described above may be combined with one or more additional embodiments, and may be changed within the range understandable to those skilled in the art in light of the above detailed description. The embodiments of the present disclosure should be understood as illustrative but not restrictive in all respects. For example, individual components described as unitary may be implemented in a distributed manner, and similarly, the components described as distributed may also be implemented in a combined form. Accordingly, all changes or modifications derived from the meanings and scopes of the claims of the present disclosure and their equivalents should be construed as being included in the scope of the present disclosure.

1. An artificial intelligence-based behavior monitoring method, the artificial intelligence-based behavior monitoring method being performed by a computing device including at least one processor, the artificial intelligence-based behavior monitoring method comprising:
generating analysis results for a detection item based on observational data for a person, who is a subject of behavior monitoring, by using a deep learning model that matches at least one detection item included in each of a plurality of detection targets; and
estimating a behavior of the person based on the generated analysis results by using a predetermined ruleset.

2. The artificial intelligence-based behavior monitoring method of claim 1, wherein:
the detection item is state information identified based on a subclass of the detection target; and
the state information is changeable according to the behavior of the person.

3. The artificial intelligence-based behavior monitoring method of claim 1, wherein the plurality of detection targets comprise one or more of a body part of the person, a thing excluding the person, a sound of an object associated with the behavior of the person, and a time of an object associated with the behavior of the person.

4. The artificial intelligence-based behavior monitoring method of claim 1, wherein the deep learning model comprises at least one of:
a first model for estimating a pose of a person based on an image;
a second model for estimating a shape and direction of a face of a person based on an image;
a third model for tracking a gaze of a person based on an image;
a fourth model for recognizing a thing other than a person based on an image; and
a fifth model for detecting a sound element of an object associated with a behavior of a person based on at least one of an image and audio.

5. The artificial intelligence-based behavior monitoring method of claim 4, wherein generating the analysis results for the detection item based on the observational data for the person, who is the subject of behavior monitoring, by using the deep learning model that matches at least one detection item included in each of the plurality of detection targets comprises:
obtaining the observational data at a predetermined cycle; and
generating analysis results for the detection item, reflecting therein a behavioral result of the person performed during the predetermined cycle, by inputting the obtained observational data to at least one of the first, second, third, fourth, and fifth models.

6. The artificial intelligence-based behavior monitoring method of claim 5, wherein the predetermined cycle is determined in accordance with environmental conditions that are set by a client in charge of behavior monitoring.

7. The artificial intelligence-based behavior monitoring method of claim 1, wherein estimating the behavior of the person based on the generated analysis results by using the predetermined ruleset comprises:
identifying analysis results that match a determination condition for each behavior class included in the predetermined ruleset among the generated analysis results;
estimating accuracy of the identified analysis results and correlation between the behavior class included in the predetermined ruleset and the identified analysis results; and
estimating a behavior of the person by combining the identified analysis results based on the estimated accuracy and correlation.

8. The artificial intelligence-based behavior monitoring method of claim 7, wherein estimating the behavior of the person by combining the identified analysis results based on the estimated accuracy and correlation comprises:
assigning a first weight based on the estimated accuracy to each of the identified analysis results;
assigning a second weight based on the estimated correlation to each of the identified analysis results; and
determining whether the person has performed at least one of behavior classes included in the predetermined ruleset based on a numerical value derived by combining the first and second weights.

9. The artificial intelligence-based behavior monitoring method of claim 8, wherein the behavior classes included in the predetermined ruleset comprise:
a first behavior class set by a client in charge of behavior monitoring and corresponding to a cheating behavior for a test; and
a second behavior class set by the client and corresponding to an abnormal behavior unnecessary for taking the test.

10. A computer program stored in a computer-readable storage medium, the computer program causing operations for monitoring behavior based on artificial intelligence to be performed when executed by at least one processor, wherein the operations comprise operations of:
generating analysis results for a detection item based on observational data for a person, who is a subject of behavior monitoring, by using a deep learning model that matches at least one detection item included in each of a plurality of detection targets; and
estimating a behavior of the person based on the generated analysis results by using a predetermined ruleset.

11. A computing device for monitoring behavior based on artificial intelligence, the computing device comprising:
a processor including at least one core;
memory including program codes executable by the processor; and
a network unit for obtaining observational data for a person who is a subject of behavior monitoring;
wherein the processor:
generates analysis results for a detection item based on observational data for a person, who is a subject of behavior monitoring, by using a deep learning model that matches at least one detection item included in each of a plurality of detection targets; and
estimates a behavior of the person based on the generated analysis results by using a predetermined ruleset.
